(19) United States
(12) Patent Application Publication
(10) Pub. No.: US 2021/0253241 A1
(43) Pub. Date: Aug. 19, 2021

(54) ELECTRIC VEHICLE WITH AN AIRBORNE LINK DEVICE FOR CONNECTING TO A POWER LINE AND AN AIRBORNE LINK DEVICE THEREOF

(71) Applicant: Gad HARAN, Haifa (IL)

(72) Inventor: Gad HARAN, Haifa (IL)

(21) Appl. No.: 16/794,412

(22) Filed: Feb. 19, 2020

(51) Int. Cl. B64C 39/02

(52) U.S. Cl. CPC B64C 39/024; B64C 39/022; B64C 2201/042; B64C 2201/148; B64C 2201/066

(57) ABSTRACT

A linking device to electrically link an electric vehicle to a power line extending along a path, may include an unmanned aerial vehicle (UAV) comprising: a controller to operate flight controls of the UAV; an electric current collector for placing in contact with and collecting an electric current from the power line; and a power cable to transfer the electric current, the cable having a distal end and a proximal end, the distal end of the cable being electrically linked to the electric current collector and the proximal end being electrically linked to an electric battery of the electric vehicle or to an electric motor of the electric vehicle. The controller is configured to operate the flight controls to cause the UAV to ascend or descend so as to facilitate contact between the electric current collector and the power line and to maintain that contact while being towed by the electric vehicle, when the electric vehicle is traveling along the path.

### FIELD OF THE INVENTION

The present invention relates to electric vehicles requiring electricity for operation. More particularly, the present invention relates to an electric vehicle powered by a power line via an airborne link.

### BACKGROUND OF THE INVENTION

An electric vehicle (EV) typically uses one or more electric motors or traction motors for propulsion. Typically, there are two methods for providing electric power to EVs: electricity provided by off-vehicle sources, or an on-board battery, solar panel or electric generator.

Vehicles powered by off-vehicle electric power sources were introduced in the mid-19^{th} century. However, except for trains, trams and some other public transport vehicles (such as trolleybuses that can be found in some eastern European countries, e.g., in the Czech Republic, Poland, and Serbia), modern vehicles are predominantly propelled by internal combustion engines. Trams, trains and trolleybuses are typically powered by an overhead power line, which is a part of a network of power lines covering the routes of these vehicles. A vehicle powered by an overhead power line is typically provided with a pantograph, which is a mechanical device mounted on top of the designated vehicle (e.g., train, tram, bus) that maintains physical contact with the power line, transmitting power to the electric motor of the vehicle. This need for a constant physical contact with the overhead powerline limits the maneuverability of the powered vehicle to routes with an overhead power line.

With the increased interest in renewable energy and growing concerns of the consequences of global warming, automobiles powered by electric batteries have been introduced, and demand for such automobiles is steadily growing. Some countries have even enacted laws setting deadlines to completely stopping the use of fossil fuel powered vehicles and moving to vehicles powered by renewable energy sources, such as electric automobiles.

To-date, one of the limiting factors of electric automobiles is the relatively short battery life, dictating short driving distances and frequent charging of the battery. The typical charging time of EV batteries is long, requiring elongated stop times. EV Batteries are also typically very heavy and may include various heavy pollutant metals which are hazardous to the environment.

Since automobiles are typically much smaller in height with respect to trains, trams, busses and trucks, a pantograph may be a bad choice to use for connecting to the power line, as it may mean placing a rather heavy metal construction that may be too much for an automobile to bear, as it has to bridge a rather large gap between the roof of the car and the catenary power line—a gap which is substantially larger than the gap between the roof of a train, tram or bus from the power line. The use of a pantograph on automobiles may also pose electrification hazards to the public and the automobile users.

Some experimental work was conducted in Europe and in the United States involving deploying catenary power lines over highways (the terms “eHighways” or “sRoads” were used to name such highways) and powering heavy trucks equipped with pantographs, while allowing other self-powered cars and lower vehicles to travel on the same highways.

In Sweden an experimental eHighway was introduced, having electricity conducting wires embedded in the asphalt road, and a movable arm underneath the EV used for connecting the EV's chargeable battery to the embedded wires for charging the battery.

In other countries (e.g., US, Sweden, Israel), experiments with wireless charging were introduced having inductive coils buried under the road surface.

In China, several patent publications (CN107215231, CN108189687, CN108263235) described the idea of an electric car that has a charging cable with a connector at its end, and a drone that is configured to connect the charging cable to a railcar that travels along an overhead conducting rail mounted on poles. The drone is used to pick-up the connector end of the charging cable from the roof of the car, fly up and connect the cable to the railcar. After performing this duty, the drone may dock on the railcar, or the car, or fly away to any other docking station.

It may be desirable to power electric vehicles by an electric power line, via an airborne link which may easily connect to and disconnect from the power line.

### SUMMARY OF THE INVENTION

There is thus provided, in accordance with an embodiment of the present invention, an airborne linking device to electrically link an electric vehicle to a power line extending along a path. The airborne linking device includes an unmanned aerial vehicle (UAV) comprising: a controller to operate flight controls of the UAV; an electric current collector comprising one or more sliding plates for placing in contact with the power line; and a power cable to transmit electric current, the cable having a distal end and a proximal end, the distal end of the cable electrically linked to the electric current collector and the proximal end electrically linked to an electric battery of the electric vehicle or to an electric motor of the electric vehicle. The controller is configured to operate the flight controls to cause the UAV to ascend or descend so as to facilitate contact between the electric current collector and the power line and maintain that contact while being towed by the electric vehicle, when the electric vehicle is traveling along the path.

According to some embodiments of the invention, the UAV linking device further includes a docking station for docking the UAV on the electric vehicle.

According to some embodiments of the invention, the docking station further includes a rotatable drum for wrapping the electric cable around the drum, wherein when the drum is rotated in a first direction a distance between the UAV and the docking station is increased, and when the drum is rotated in a second opposite direction the distance between the UAV and the docking station is decreased. The drum may be used to wind excess cable to avoid unnecessary slack of the cable, or to unwind the cable when it is necessary to extend the cable reach.

According to some embodiments of the invention, the rotatable drum is on board the UAV.

According to some embodiments of the invention, the UAV includes one or a plurality of rotors operated by an electric motor powered by a UAV battery configured to be charged via the electric current collector.

According to some embodiments of the invention, the UAV comprises one or a plurality of rotors operated by an electric motor powered by a UAV battery configured to be charged via the electric cable.

According to some embodiments of the invention, the power line includes two substantially parallel electric lines, and the electric current collector includes at least one pair of sliding plates, a first sliding plate of the pair for contacting a first electric line of the two substantially parallel electric lines and a second sliding plate of the pair for contacting a second electric line of the two substantially parallel electric lines.

According to some embodiments of the invention, the controller is configured to operate the flight controls of the UAV so as to cause the UAV to ascend in order to bring the electric current collector to contact with the power line or to descend the UAV in order to disengage the electric current collector from the power line.

According to some embodiments of the invention, the controller is configured to operate the flight controls of the UAV so as to cause the UAV to descend in order to bring the electric current collector to contact with the power line or to ascend the UAV in order to disengage the electric current collector from the power line.

According to some embodiments of the invention, the UAV linking device includes one or a plurality of imaging devices, for imaging one or more fields of view to identify the power line, and wherein the controller is configured to obtain image data from said one or more imaging devices and operate the flight control to maneuver the UAV.

According to some embodiments of the invention, the controller is configured to receive a turning indication and operate the flight controls of the UAV so as to cause the UAV to maneuver the UAV in order to disengage the electric current collector from the overhead power line, to identify another power line and to maneuver in order to bring the electric current collector to contact with the other power line.

According to some embodiments of the invention, the UAV is selected from the group of unmanned aerial vehicles consisting of: a drone, a tethered drone, vertical take-off and landing (VTOL) aircraft, and a kite.

According to some embodiments of the invention, the flight controls are selected from the group of controls consisting of: rotor, rotors, airfoils, ailerons, elevators, and rudder.

According to some embodiments of the invention, the electric current collector further comprises an electromagnet, and wherein the controller is configured to activate the electromagnet to induce an attracting force between the electric current collector and a ferromagnetic element along the power line or to deactivate the electromagnet.

According to some embodiments of the invention, said one or more sliding plates of the electric current collector are top facing.

According to some embodiments of the invention, said one or more sliding plates of the electric current collector are down facing.

According to some embodiments of the invention, there is provided an EV that includes an electric motor to propel the EV; a battery to power an electric circuit of the EV; and an airborne linking device to electrically link the battery or the electric motor to a power line extending along a path, the device comprising: an unmanned aerial vehicle (UAV) comprising: a controller for operating flight controls of the UAV; an electric current collector comprising one or more sliding plates for placing in contact with the power line; and a power cable to transmit electric current, the cable having a distal end and a proximal end, the distal end of the cable electrically linked to the electric current collector and the proximal end electrically linked to an electric battery of the electric vehicle or to an electric motor of the electric vehicle. The controller is configured to operate the flight controls to cause the UAV to ascend or descend so as to facilitate contact between the electric current collector and the power line and to maintain that contact while being towed by the electric vehicle, when the electric vehicle is traveling along the path.

According to some embodiments of the invention, there is provided an AV (Aerial Vehicle) that includes an electric motor to propel the AV; a battery to power an electric circuit of the AV; an electric current collector to electrically link the battery or the electric motor to a power line extending along a path, the electric current collector comprising one pair or more sliding plates for placing in contact with the power line; a controller that is configured to operate the flight controls to cause the AV to ascend or descend so as to facilitate contact between the electric current collector and the power line and maintain that contact while being driven the along the path.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 shows an electric vehicle with an airborne link to electrically link the EV to an overhead power line, according to some embodiments of the present invention.

FIG. 2 shows an electric vehicle with an airborne link to link the EV to an overhead power line and ground line, according to some embodiments of the present invention.

FIG. 3A shows a lateral side view of a UAV used as an airborne link device for linking an EV to an overhead power line, with a pair of sliding plates, according to some embodiments of the present invention.

FIG. 3B shows a front view of the UAV used as an airborne link device shown in FIG. 3A, for linking to an overhead power line, according to some embodiments of the present invention.

FIG. 3C shows a top view of the UAV used as an airborne link device shown in FIG. 3A, for linking to an overhead power line, according to some embodiments of the present invention.

FIG. 4 shows a top view of a UAV used as an airborne link device for linking to an overhead dual power line, according to some embodiments of the present invention.

FIG. 5 shows a cross section of a power line, according to some embodiments of the present invention.

FIG. 6 shows an electric vehicle with an airborne link to electrically link the EV to an overhead power line, according to some embodiments of the present invention, showing some electrical components of the EV.

FIG. 7A shows a lateral view of an AV (Aerial Vehicle) with a top electric current collector to electrically link the AV to a power line, according to some embodiments of the present invention.

FIG. 7B shows a top view of the AV with a top electric current collector to electrically link the AV to a power line shown in FIG. 7A, according to some embodiments of the present invention.

FIG. 8 shows a dual power line powering two AVs with an airborne link in traffic.

FIG. 9A shows a lateral view of an airborne link device to electronically link an electric vehicle to a power line by ascending onto the power line, according to some embodiments of the present invention.

FIG. 9B shows a top view of the airborne link device shown in FIG. 9A, according to some embodiments of the present invention.

FIG. 10 shows an electric aircraft with an airborne link to link the EV to a power line, according to some embodiments of the present invention.

FIG. 11 shows a controller device for an EV for controlling the operation of an airborne link device, according to some embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although some embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

Some embodiments of the present invention are aimed at providing a solution for charging the battery or batteries of an electric vehicle and/or providing direct electrical power to power an electric vehicle using an overhead power line installed at a height above a road. “Electric vehicle” in the context of the present invention may refer to an electric vehicle and/or to a hybrid vehicle. An electric vehicle can be either ground vehicle (i.e., electric car, electric truck etc.), amphibious, water vehicle or an Aerial Vehicle—AV (i.e., Electric plane, electric helicopter or electric drone etc.). A tethered UAV, connected to the vehicle via electricity conducting cable, may fly under a transmission line, touching it with an electricity conducting apparatus, thus conveying electricity to the hybrid or electric vehicle.

According to some embodiments of the present invention, a novel UAV-operated electric link is provided aimed at connecting the battery and/or the electric circuit of an EV to an overhead power line (e.g., catenary power line). A UAV linked by an electric cable to the battery and/or electric circuitry of the EV is configured to fly along an overhead power line with a collecting device that includes one or a plurality of electrically conductive elements kept in contact with the power line, and transferring the electricity power via the cable to the EV's battery and/or electric circuitry.

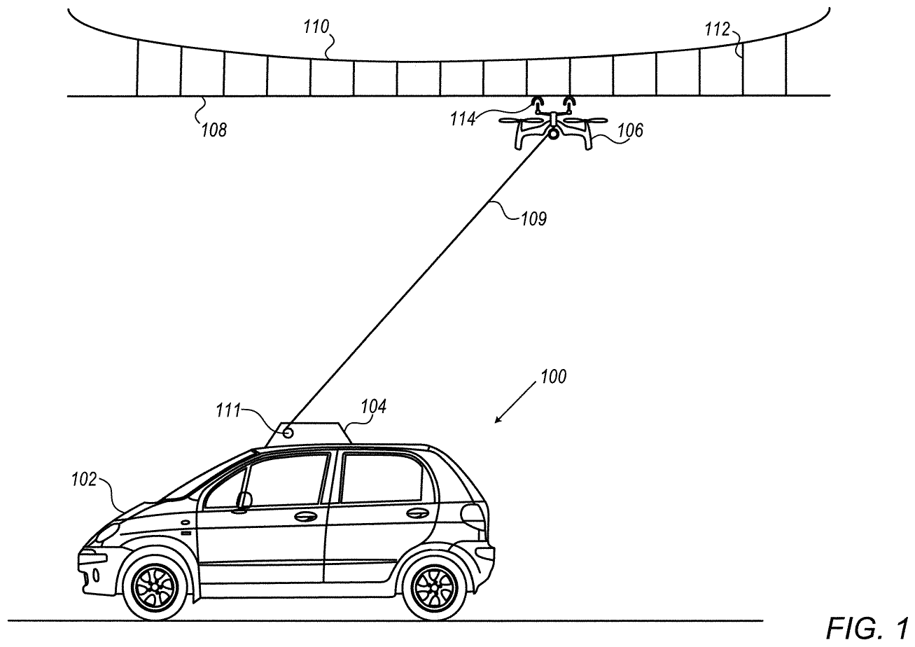

FIG. 1 shows an electric vehicle with an airborne link device to electrically link the EV to an overhead power line, according to some embodiments of the present invention.

EV 100 comprises a car 102 which is configured to receive electric power from an overhead power line 108. Power line 108 may be, for example current line 108 suspended from a catenary line 110 by auxiliary wires 112. Car 102 is provided with a docking station 104 on a top surface of the car 102, e.g., on the roof.

An UAV 106 is provided with an electric current collector 114 on top of the UAV, designed to be placed in contact with the power line and be electrically linked to a distal end of electric cable 109.

The electric current collector may include sliding plates that include metalized carbon or other electrically conducting material as a top layer, an insulation holding bracket and an insulated electric cable 109.

The proximal end of the electric cable 109 may be electrically linked to the battery of the EV, to charge the battery and/or linked to provide electric power to the electric motor of the EV when the electric current collector is in contact with the overhead power line. Typically, such power line is provided overhead along a road. A network of roads may be covered by a corresponding network of overhead power lines, with each road having at least one power line for each allowed traffic direction (e.g., one power line for a one-way road, two power lines for a two-way road, four power lines for four traffic lanes, etc.).

When operated, the UAV is configured to ascend and approach the power line until the electric current collector is placed in contact with the power line. As the EV travels along the road, the UAV is pulled by cable attached to the EV, and is configured to apply a lifting force to maintain the electric current collector 114 in contact with the power line, and, if necessary, to maneuver to remain under the power line or within a predetermined distance from the power line so as to keep the electric current collector in constant contact with the power line and follow the power line.

The docking station 104 may include a rotatable drum 111 for wrapping and unwrapping the electric cable 109 around the drum. When the drum 111 is rotated in one direction, the electric cable is wrapped around the drum, thereby decreasing the distance between the UAV and the docking station (on the EV), and, when the drum is rotated in an opposite direction, the electric cable is unwrapped, thereby increasing the distance between the UAV and the docking station.

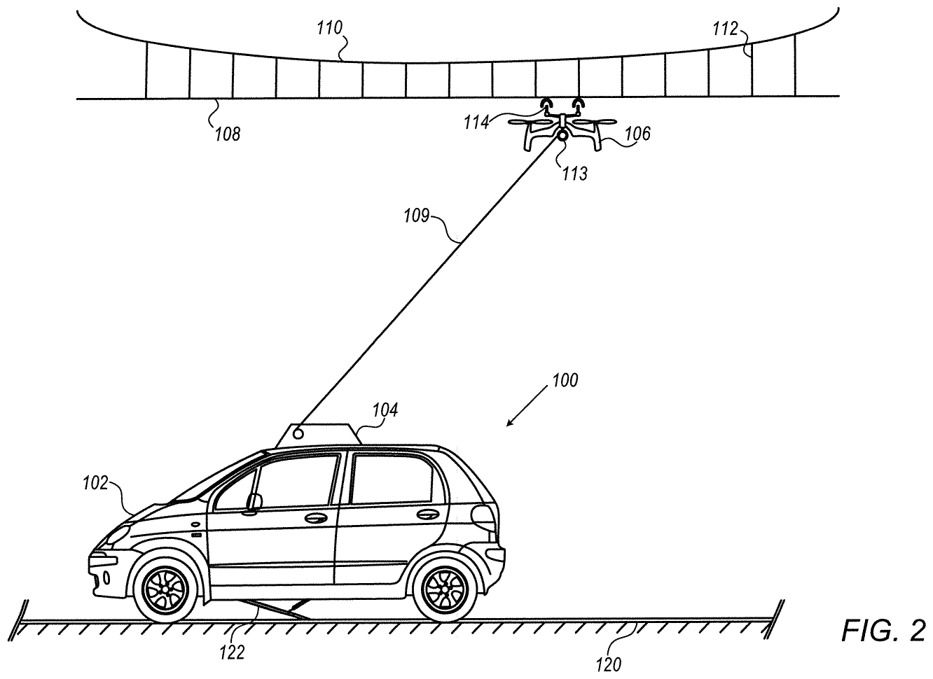

In some embodiments of the present invention, the rotatable drum may be located on or inside the UAV (see 113 in FIG. 2). However, if it is desired to minimize the weight of the UAV, it may be prudent to place the rotatable drum on the EV instead (as shown in FIG. 1).

In some embodiments of the present invention, the UAV link device is used to provide electricity for charging the battery of the EV and/or to power the electric motor of the EV.

For battery charging purposes, in some embodiments of the invention, it is not necessary to keep the UAV in the air constantly in contact with the power line, so when there is no need to charge the battery, e.g., when the battery is full, or above a charge level that requires charging, or when the driver believes there is no need for charging, the UAV may be hauled back onto the docking stations 104 and remain docked until it is required to electrically link to the power line.

According to some embodiments of the present invention, a controller is configured to monitor the charge level of the battery and, when the battery charge level declines to a predetermined threshold charge level or drops below that threshold charge level, to operate the UAV link device to engage with the power line to charging. In some embodiments of the invention, a user (e.g., the driver of the EV) may voluntarily initiate the linking of the UAV link device to the power line.

As electric circuits require two conductors for electricity, an overhead power line may include two separate substantially parallel electrically conducting lines, e.g., one serving as a power line and the other as a return line.

In some embodiments of the invention, a return line may be embedded in the road. FIG. 2 shows an electric vehicle with an airborne link to link the EV to an overhead power line and a ground return line, according to some embodiments of the present invention.

A return line 120, for example a rail, may be embedded in the road. A road line collector, in the form of a bottom connecting arm 122 may be provided suspended from the chassis of the EV, which serves as a second electric port of the EV (the UAV link device acting as a first electric port), may be operated to extend to obtain a direct electrical contact with return line 120, when it is necessary to remain in contact with the return line, and may be retracted when idle. The operation of the road line collector may be governed by a vehicle computer.

The power line, whether both power and return lines are overhead or whether one line is overhead and the other line is not overhead (e.g., embedded in the road), may provide alternating current (AC) or direct current (DC). Typically, the supply voltage of the power line may be in a range of 110-750 Volts, so as to match the required charging voltage for EVs. According to the US-based society of automotive engineers (SAE), there may be several voltage levels for charging EV batteries. Voltage of 120 Volts (V) AC is considered as a first charging level, 240 V AC is a second charging level, and a third supercharging level may be 480 V AC or higher. Providing voltage for powering an EV motor may require high voltages (trams and trolleybuses typically require 500 to 750 Volts).

In some embodiments of the invention, the UAV may include a battery configured to be charged by electric current collected by the electric current collector. In some embodiments, the battery of the UAV may be charged electric current from the electric battery of the EV, via the electric cable.

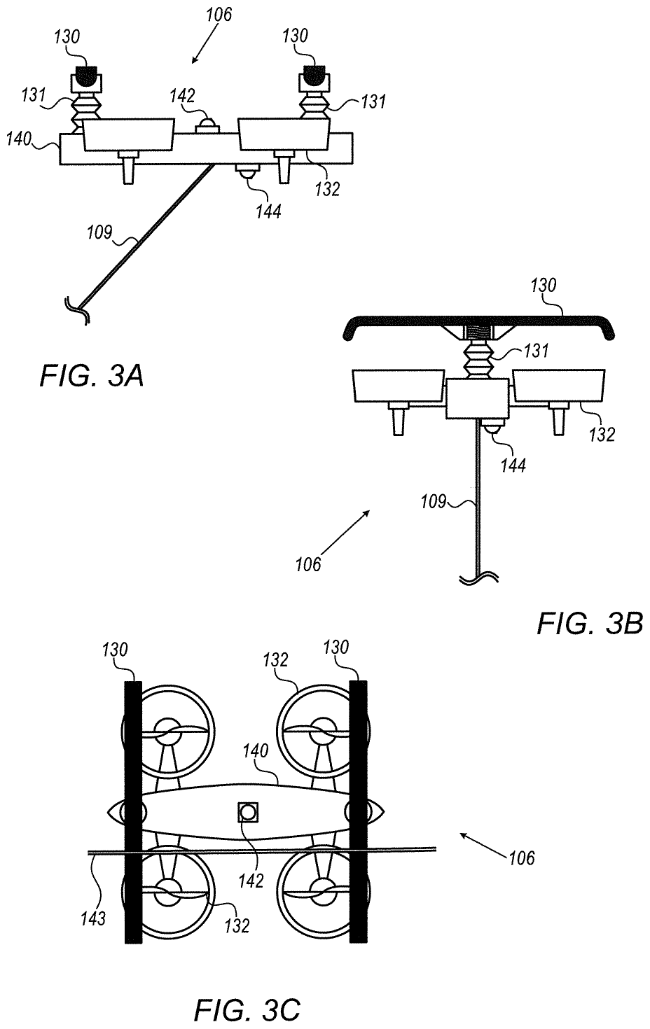

FIG. 3A shows a lateral side view of a UAV used as an airborne link device for linking an EV to an overhead power line, with a pair of sliding plates, according to some embodiments of the present invention. The sliding plates may be rotatable to allow them to rotate to occupy less space when stowed away or docked on the docking station, to and rotate to redeploy when operative.

UAV 106 may be a drone, for example a tethered drone, comprising a body 140 with a plurality of flight controls, e.g., rotors 132, which when operated may lift the UAV, ascend to engage the sliding plates 130, supported on arms 131, with the power line, to facilitate an electrical contact, descend to disengage the sliding plates from the power line, and maneuver the drone so as to keep tracking the power line and maintaining the electrical contact. In some embodiments of the present invention, the UAV may be selected from the group of UAVs consisting of a drone, quadcopter, a tethered drone, vertical take-off and landing (VTOL) aircraft, a kite.

While a single sliding plate 130 may suffice to establish electrical contact with a single power line, in some embodiments of the present invention two or more sliding plates may be provided for redundancy to ensure the electrical contact is maintained, even for a single power line.

An overhead imaging device (e.g., a video camera) 142 may be provided on the UAV, directed upwards overhead imaging device, for imaging a first field of view above the UAV to identify the overhead power line. Imaged data acquired by the overhead imaging device may be analyzed to determine the location of the power line over the UAV, and the controller may be configured to operate the flight controls to maneuver the UAV towards the overhead power line. The flight controls may include, for example, rotor, rotors, airfoils, ailerons, elevators, and rudder.

Another imaging device, a down-facing imaging device 144, may also be provided, located at a low position (e.g., the belly of the UAV) for imaging a second field of view below the UAV. For example, the road below and/or the road ahead of the UAV. The controller may be configured to analyze the image data acquired by the down-facing imaging device and maneuver the UAV based on the analyzed image data collected using the down facing imaging device.

The UAV may also include beside the imaging device/s other sensors (e.g., thermometer, altimeter, accelerometer, navigational sensor (e.g., GPS), etc., for monitoring external conditions. Sensed data may be analyzed by the controller and used for analyzing the traffic condition (e.g., traffic density), weather conditions, navigation of the UAV, billing data and billing counter, and more.

In some embodiments of the present invention, the EV may be provided with a user interface (UI) application (e.g., software or hardware based) for communicating with the UAV (e.g., using wireless communication, such as, for example, Bluetooth). In some embodiments, the UI is configured to allow the user (e.g., the driver) to send commands and/or data and receive data, for example, on electrical management of the EV.

FIG. 3B shows a front view of the UAV used as an airborne link device shown in FIG. 3A, for linking to an overhead power line, according to some embodiments of the present invention.

FIG. 3C shows a top view of the UAV used as an airborne link device shown in FIG. 3A, for linking to an overhead power line, according to some embodiments of the present invention. The UAV link device in this example has two sliding plates 130, which are used to establish and maintain electric contact with power line 143.

In some embodiments, the overhead power line may include two electric lines—a first power line and a second return line. The electric current collector may include at least one pair of sliding plates, a first sliding plate of the pair for contacting the first power line and a second sliding plate of the pair for contacting the second return line.

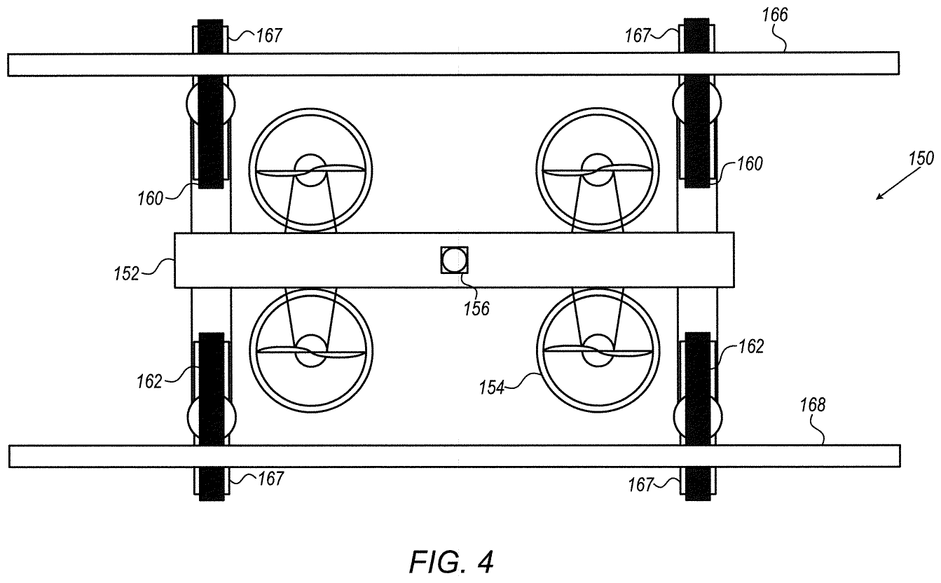

FIG. 4 shows a top view of a UAV 150 of a UAV used as an airborne link device for linking to an overhead dual power line, according to some embodiments of the present invention. UAV 150 may include a plurality of rotors 154, connected to body 152. An overhead imaging device 156 may be provided on a top surface of the body 152 of UAV 150. A down-facing imaging device may also be provided (not shown in this figure).

Two pairs of sliding plates 160, 162 are provided, each pair configured to establish and keep electric contact with either of the two lines of the power line—sliding plate 160 for contacting one power line 166 and sliding plate 162 for contacting the other power line 168.

The sliding plates of the electric current collector may include one or a plurality of electromagnets 167, which, when activated, induce an attracting force between the electric current collector and a ferromagnetic element along the power line or to deactivate the electromagnet. The electromagnetic attracting force may reduce or even eliminate the lift power required for the UAV to maintain contact with the overhead power line, which may substantially save energy and may allow for the use of UAVs that have very limited payload weight allowance or are relatively weaker than large state-of the art strong UAVs.

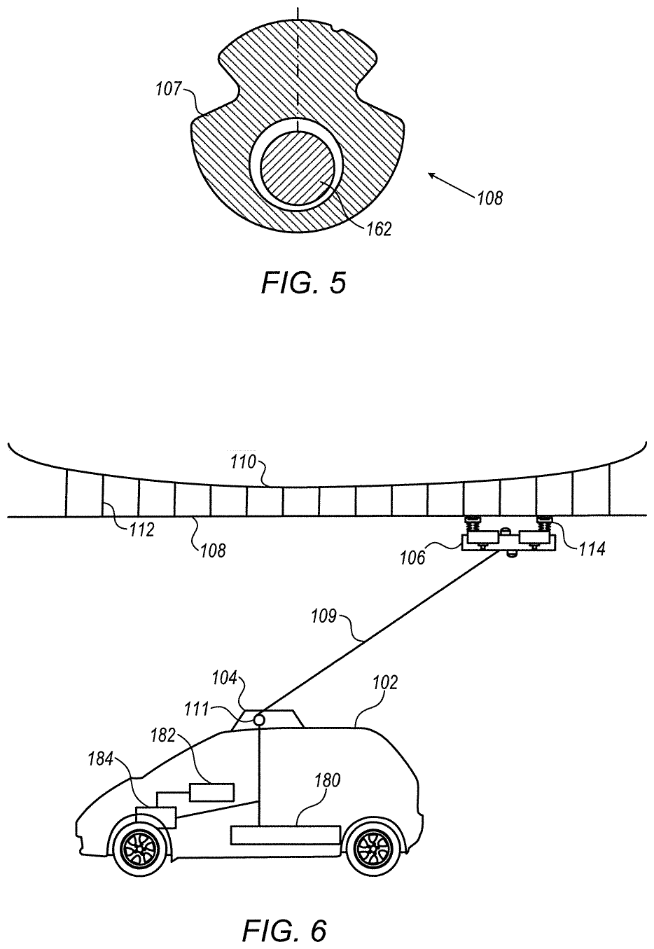

FIG. 5 shows a cross section of a power line, according to some embodiments of the present invention.

Typically, a contact wire is made of solid copper, which is a good electric conductor. A catenary cable (sometimes also called “messenger cable”) typically needs to be both strong and made of good conducting material. Copper, aluminum, or steel may typically be used for the catenary cable.

In some embodiments of the present invention, the power line 108 may include a ferromagnetic metal core 162, encapsulated in a hollow copper contact wire 107. The ferromagnetic core may interact with the electromagnets of the UAV, ensuring the existence of electromagnetic attraction force between the electromagnets of the electric current collector of the UAV and the power line, and reducing the UAV lifting force required from the UAV to maintain electrical contact with the overhead power line.

FIG. 6 shows an electric vehicle with an airborne link device to electrically link the EV to an overhead power line, according to some embodiments of the present invention, showing some electrical components of the EV. The proximal end of cable 109 may be electrically linked to the EV battery 180, for charging the battery, and/or electrically linked to the electric motor 184 of the EV, for directly powering the electric motor and other electric components 182 of the electric circuit of the EV. In some embodiments, the EV may be provided with electricity management system (e.g., software or hardware application) for monitoring and managing the electric link of the UAV link device to the EV battery or the EV electric motor.

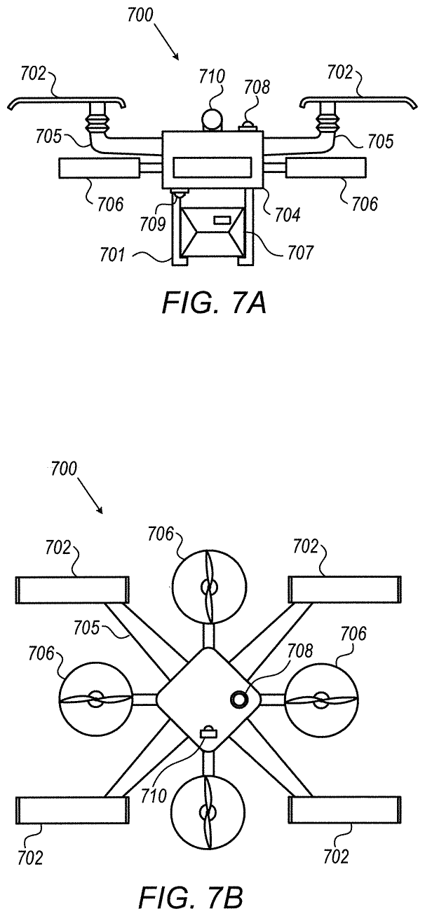

FIG. 7A shows a lateral view of a AV 700 with an electric current collector to electrically link the AV to a power line, according to some embodiments of the present invention. FIG. 7B shows a top view of the AV with an electric current collector to electrically link the AV to a power line shown in FIG. 7A, according to some embodiments of the present invention.

AV 700 is an electrically powered aircraft, which is configured to obtain power from a dual power line (two electric lines to which the electric circuit of the AV 700 is electrically coupled to obtain the required voltage). AV 700 may include body 704, with electrically powered rotors 706 to provide lift force and other forces required to fly and maneuver the AV. AV 700 may be designed to transport loads, such as, for example, parcel 707, which may be held by arms 701, or a passengers cabin. AV 700 may be provided with one or a plurality of imaging devices, such as top facing camera 708, forward facing camera 710 and bottom facing camera 709 so as to allow the controller of the AV to obtain views of sectors above, below and in front of the AV. Obtained image data from such imaging devices may be used by a controller of the AV to track the power line and may be used for directing the AV to engage, disengage or maintain contact with the power line, as may be required.

Arms 705 extending from body 704 support one or more pairs of top facing sliding plates 702, which are made of electrically conductive material and are designed to attain physical contact with a dual power line to provide voltage from the dual power line to the electrical circuit of the AV 700. The AV, according to some embodiments of the invention, may be configured to periodically engage, via he sliding plates 702, with the dual power line to charge one or more rechargeable batteries for powering the AV, or may be configured to constantly engage with the dual power line via sliding plates 702 to power the rotors and other electric components of the AV.

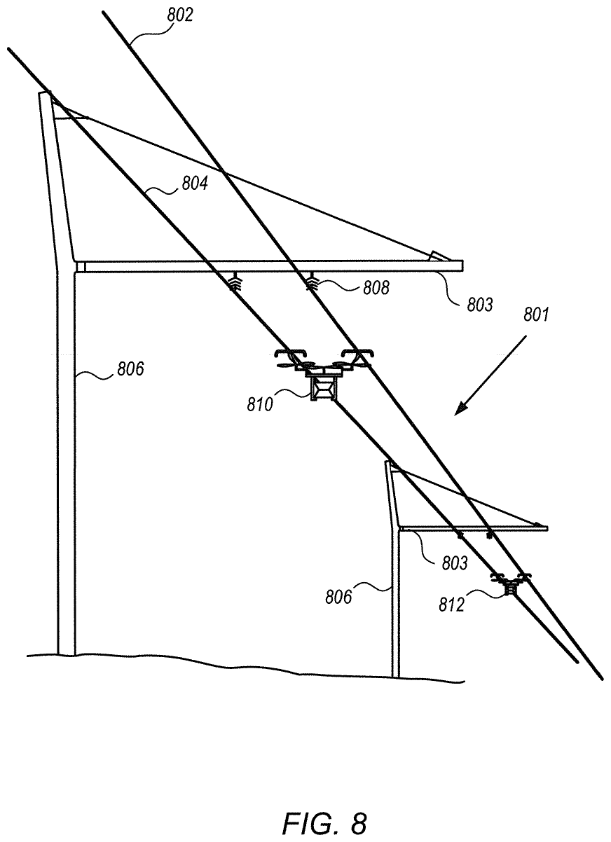

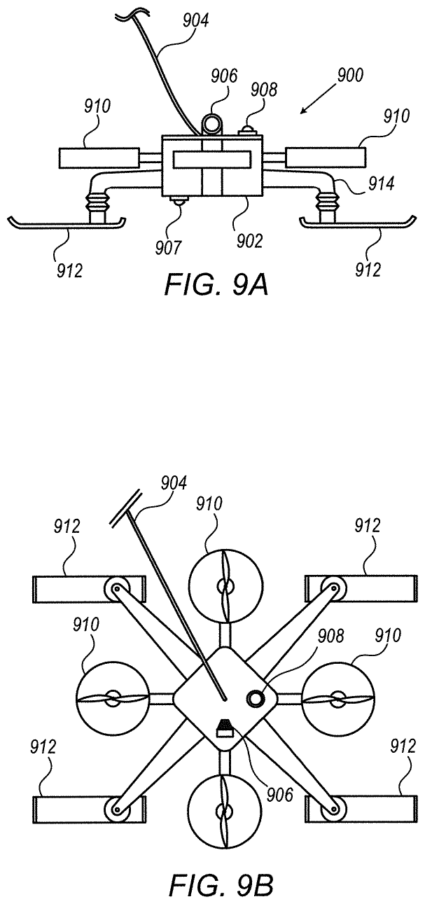

FIG. 8 shows a dual power line powering airborne electric vehicles with an airborne link device and traffic of AVs 810. Dual power line 801 may comprise two substantially parallel lines 802, 804, made of electrically conducting material which are linked to a power grid and provide AC or DC voltage. The power lines are supported by bars 803 (e.g., using isolating suspensions 808) extending from poles 806 (e.g., substantially horizontally) and stretch between adjacent poles 806 along one or more routes, so as to define a powered path or a powered network of paths, for powering electric vehicles having airborne link devices for electrically linking to the power line. According to some embodiments of the invention, power lines 802, 804 suspended below horizontal bars 803 may be suitable for electric vehicles with airborne link that is configured to ascend to the power line. In other embodiments of the invention, the power lines may be laid on top of horizontal bars which are designed to power electric vehicles having an airborne link that is configured to descend to the power line (see, for example, FIGS. 9A and 9B).

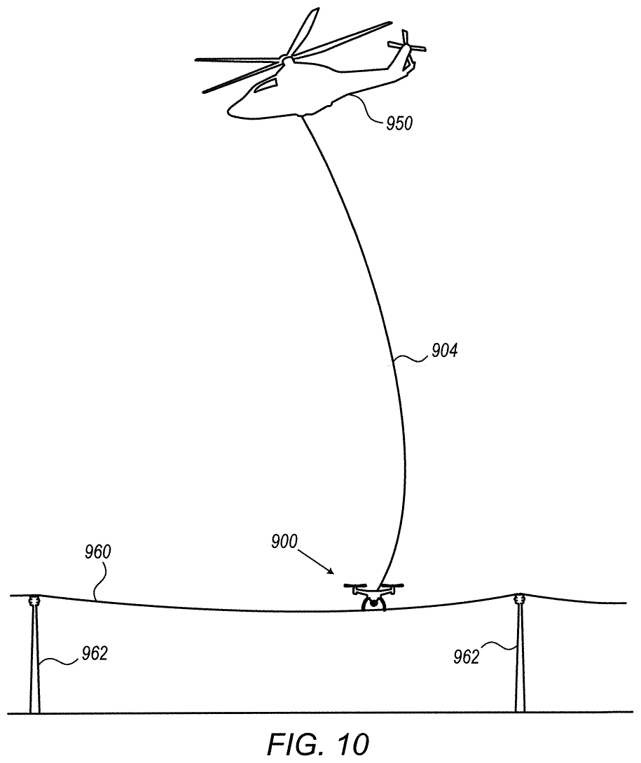

FIG. 9A shows a lateral view of an airborne link device 900 (e.g., UAV) to electronically link an electric vehicle (e.g., an electric aircraft—see FIG. 10) to a power line, by ascending onto the power line, according to some embodiments of the present invention.

FIG. 9B shows a top view of the airborne link device shown in FIG. 9A, according to some embodiments of the present invention.

UAV 900 may include body 902 equipped with rotors 910, for providing lift force and other forces required to fly and maneuver the UAV. Arms 914 extending from the body 902 are provided for supporting at least one pair of down facing sliding plates 912. UAV 900 may also include one or more imaging devices, such as top facing camera 908 and bottom facing camera 907, for providing image data that may be used by a controller of the UAV to navigate the UAV, e.g., for tracking the power line and/or the road, and for identifying a power line and for navigating the UAV to and away from the power line. Power cable 904 may extend form the airborne link device 900, some of which may be wound around drum 906. Drum 906 may be used to wind excess cable to avoid unnecessary slack of the cable, or to unwind the cable when it is necessary to extend the cable reach.

FIG. 10 shows an electric aircraft with an airborne link device to link the EV to a power line, according to some embodiments of the present invention. Electrically powered helicopter 950 may be provided with an airborne link device 900 which is linked to the electric circuitry of the helicopter 950 via electric cable 904. In this example, airborne link device 900 is designed to descend to the power line and maintain physical contact between the sliding plates of the airborne link device 900 and the power line 960. Power line 960 is supported on top poles 962 and extends between the poles.

In general, the airborne link device, according to some embodiments of the invention may be configured to periodically engage with the power line to charge one or more rechargeable batteries for powering the electric vehicle, or may be configured to constantly engage with the power line to power the electric circuitry of the electric vehicle.

While some of the figures (FIG. 1, FIG. 6, FIG. 10) depict a single power line, it should be understood that, for some embodiments of the invention, e.g., airborne electric vehicles and other electric vehicles, a ground line (as in FIG. 2) may not apply, such that the power line for such electric vehicles would include two power lines.

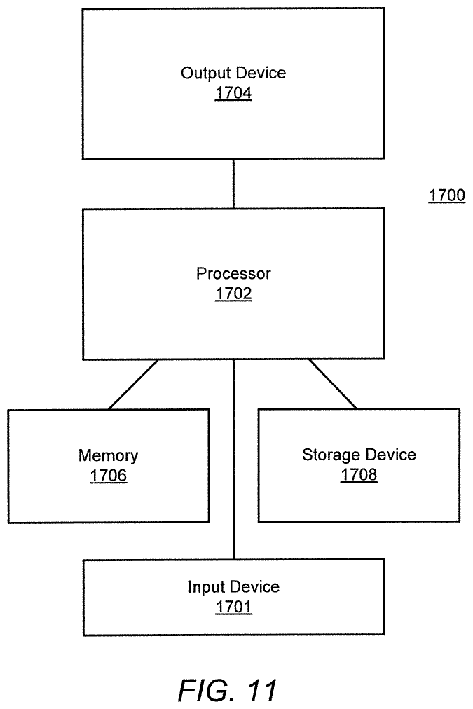

FIG. 11 shows a controller 1700 device for an EV for controlling the operation of a UAV link device, according to some embodiments of the present invention.

Controller 1700 may include a processor 1702 (e.g., single processor or a processing unit made that includes a plurality of processors, on a single machine or distributed on a plurality of machines) for controlling a UAV link device according to some embodiments of the present invention. Processing unit 1702 may be configured to perform a method according to some embodiments of the invention and to perform other actions and processing according to some embodiments of the present invention.

Processor 1702 may be linked with memory 1706 on which a program implementing a method according to some embodiments of the present invention and corresponding data may be loaded and from which it may be run, and storage device 1708, which includes a non-transitory computer readable medium (or mediums) such as, for example, one or a plurality of hard disks, flash memory devices, etc. on which a program implementing a method according to some embodiments of the present invention and corresponding data may be stored. Controller 1700 may further include an output device 1704 (e.g., display device such as CRT, LCD, LED etc.) on which one or a plurality user interfaces associated with a program implementing a method according to some embodiments of the present invention and corresponding data may be presented. Controller 1700 may also include input interface 1701, such as, for example, one or a plurality of keyboards, pointing devices, touch sensitive surfaces (e.g. touch sensitive screens), etc. for allowing a user to input commands and data.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An airborne linking device to electrically link an electric vehicle to a power line extending along a path, comprising:
an unmanned aerial vehicle (UAV) comprising:
a controller to operate flight controls of the UAV;
an electric current collector comprising one or more sliding plates for placing in contact with the power line; and
a power cable to transmit electric current, the cable having a distal end and a proximal end, the distal end of the cable electrically linked to the electric current collector and the proximal end electrically linked to an electric battery of the electric vehicle or to an electric motor of the electric vehicle,
wherein the controller is configured to operate the flight controls to cause the UAV to ascend or descend so as to facilitate contact between the electric current collector and the power line and to maintain that contact while being towed by the electric vehicle, when the electric vehicle is traveling along the path.

2. The device of claim 1, further comprising a docking station for docking the UAV on the electric vehicle.

3. The device of claim 2, wherein the docking station further comprises a rotatable drum for wrapping the electric cable around the drum, wherein:
when the drum is rotated in a first direction, a distance between the UAV and the docking station is increased, and
when the drum is rotated in a second direction opposite to the first direction, the distance between the UAV and the docking station is decreased.

4. The device of claim 1, wherein the UAV further comprises a rotatable drum for wrapping the electric cable around the drum, wherein:
when the drum is rotated in a first direction, a distance between the UAV and the electric vehicle is increased, and
when the drum is rotated in a second direction opposite to the first direction, the distance between the UAV and the electric vehicle is decreased.

5. The device of claim 1, wherein the UAV comprises one or a plurality of rotors operated by an electric motor powered by a UAV battery configured to be charged via the electric current collector.

6. The device of claim 1, wherein the UAV comprises one or a plurality of rotors operated by an electric motor powered by a UAV battery configured to be charged via the electric cable.

7. The device of claim 1, wherein the power line comprises two substantially parallel electric lines, and wherein the electric current collector comprises at least one pair of sliding plates, a first sliding plate of the pair for contacting a first electric line of the two substantially parallel electric lines and a second sliding plate of the pair for contacting a second electric line of the two substantially parallel electric lines.

8. The device of claim 1, wherein the controller is configured to operate the flight controls of the UAV so as to cause the UAV to ascend in order to bring the electric current collector to contact with the power line or to descend the UAV in order to disengage the electric current collector from the power line.

9. The device of claim 1, wherein the controller is configured to operate the flight controls of the UAV so as to cause the UAV to descend in order to bring the electric current collector to contact with the power line or to cause the UAV to ascend in order to disengage the electric current collector from the power line.

10. The device of claim 1, further comprising one or a plurality of imaging devices, for imaging one or more fields of view to identify the power line, and wherein the controller is configured to obtain image data from said one or more imaging devices and operate the flight control to maneuver the UAV based on the imaged data.

11. The device of claim 10, wherein the controller is configured to receive a turning indication and operate the flight controls of the UAV so as to cause the UAV to maneuver the UAV in order to disengage the electric current collector from the power line, to identify another power line and to maneuver in order to bring the electric current collector to contact with the other power line.

12. The device of claim 1, wherein the UAV is selected from the group of unmanned aerial vehicles consisting of: a drone, quadcopter, a tethered drone, vertical take-off and landing (VTOL) aircraft, and a kite.

13. The device of claim 1, wherein the flight controls are selected from the group of controls consisting of: rotor, rotors, airfoils, ailerons, elevators, and a rudder.

14. The device of claim 1, wherein the electric current collector further comprises an electromagnet, and wherein the controller is configured to activate the electromagnet to induce an attracting force between the electric current collector and a ferromagnetic element along the power line or to deactivate the electromagnet.

15. The device of claim 1, wherein said one or more sliding plates of the electric current collector are top facing.

16. The device of claim 1, wherein said one or more sliding plates of the electric current collector are down facing.

17. An aerial vehicle (AV) comprising:
an electric motor to propel the AV;
a battery to power an electric circuit of the AV;
an electric current collector to electrically link the battery or the electric motor to a power line extending along a path, the electric current collector comprising one or more pairs of sliding plates for placing in contact with the power line; and
a controller that is configured to operate the flight controls to cause the AV to ascend or descend so as to facilitate contact between the electric current collector and the power line and maintain that contact while flying the along the path.

18. An electric vehicle (EV) comprising:
an electric motor to propel the EV;
a battery to power an electric circuit of the EV; and
an airborne linking device to electrically link the battery or the electric motor to a power line extending along a path, the device comprising:
an unmanned aerial vehicle (UAV) comprising:
a controller for operating flight controls of the UAV;
an electric current collector comprising one or more sliding plates for placing in contact with the power line; and
a power cable to transmit electric current, the cable having a distal end and a proximal end, the distal end of the cable electrically linked to the electric current collector and the proximal end electrically linked to an electric battery of the electric vehicle or to an electric motor of the electric vehicle,
wherein the controller is configured to operate the flight controls to cause the UAV to ascend or descend so as to facilitate contact between the electric current collector and the power line and maintain that contact while being towed by the electric vehicle, when the electric vehicle is traveling along the path.

19. The EV of claim 18, further comprising a docking station for docking the UAV on the electric vehicle.

20. The EV of claim 19, wherein the docking station further comprises a rotatable drum for wrapping the electric cable around the drum, wherein:
when the drum is rotated in a first direction, a distance between the UAV and the docking station is increased, and
when the drum is rotated in a second direction opposite to the first direction, the distance between the UAV and the docking station is decreased.

21. The EV of claim 18, wherein the UAV further comprises a rotatable drum for wrapping the electric cable around the drum, wherein:
when the drum is rotated in a first direction, a distance between the UAV and the electric vehicle is increased, and
when the drum is rotated in a second direction opposite to the first direction, the distance between the UAV and the electric vehicle is decreased.

22. The EV of claim 18, wherein the UAV comprises one or a plurality of rotors operated by an electric motor powered by a UAV battery configured to be charged by electric current collected by the electric current collector.

23. The EV of claim 18, wherein the UAV comprises one or a plurality of rotors operated by an electric motor powered by a UAV battery configured to be charged by electric current from the electric battery of the electric vehicle, passed by the electric cable.

24. The EV of claim 18, wherein the overhead power line comprises two substantially parallel electric lines, and wherein the electric current collector comprises at least one pair of sliding plates, a first sliding plate of the pair for contacting a first electric line of the two substantially parallel electric lines and a second sliding plate of the pair for contacting a second electric line of the two substantially parallel electric lines.

25. The EV of claim 18, wherein the controller is configured to operate the flight controls of the UAV so as to cause the UAV to ascend in order to bring the electric current collector to contact with the power line or to cause the UAV to descend in order to disengage the electric current collector from the power line.

26. The EV of claim 18, wherein the controller is configured to operate the flight controls of the UAV so as to cause the UAV to descend in order to bring the electric current collector to contact with the power line or to ascend the UAV in order to disengage the electric current collector from the power line.

27. The EV of claim 23, wherein the UAV further comprises one or a plurality of imaging device, for imaging one or more fields of view around the UAV to identify the power line, and wherein the controller is configured to operate the flight control to maneuver the UAV towards the power line.

28. The EV of claim 27, wherein the controller is configured to receive a turning indication and to operate the flight controls of the UAV so as to cause the UAV to disengage the electric current collector from the power line, to identify another power line and to bring the electric current collector to contact with the other power line.

29. The EV of claim 18, wherein the UAV is selected from the group of unmanned aerial vehicles consisting of: a drone, a tethered drone, vertical take-off and landing (VTOL) aircraft, and a kite.

30. The EV of claim 18, wherein the flight controls are selected from the group of controls consisting of: rotor, rotors, airfoils, ailerons, elevators, and a rudder.

31. The EV of claim 18, wherein the electric current collector further comprises an electromagnet, and wherein the controller is configured to activate the electromagnet to induce an attracting force between the electric current collector and a ferromagnetic element along the power line or to deactivate the electromagnet.

32. The EV of claim 18, wherein the electric vehicle is an electrically powered aircraft.

33. The EV of claim 32, wherein the aircraft is a helicopter.
